(19) United States
(12) Patent Application Publication
(10) Pub. No.: US 2025/0275018 A1
(43) Pub. Date: Aug. 28, 2025

(54) HEATING DEVICE

(71) Applicant: KYOCERA Corporation, Kyoto-shi, Kyoto (JP)

(72) Inventors: Yoshihiko KISAKI, Kirishima-shi, Kagoshima (JP); Ippei SUZUKI, Kirishima-shi, Kagoshima (JP)

(73) Assignee: KYOCERA Corporation, Kyoto-shi, Kyoto (JP)

(21) Appl. No.: 18/858,099

(22) PCT Filed: Apr. 17, 2023
(86) PCT No.: PCT/JP2023/015380

§ 371 Date: Oct. 18, 2024

(30) Foreign Application Priority Data
Apr. 27, 2022 (JP) 2022-073551

(51) Int. Cl. H05B 3/14; H05B 3/06

(52) U.S. Cl. CPC H05B 3/141; H05B 3/06; H05B 2203/003

(57) ABSTRACT

A heating device includes a heating plate and a plurality of heaters. The heating plate includes a heating surface and a plurality of recessed portions on a back surface opposite to the heating surface. Each of the plurality of heaters is positioned in a respective one of the plurality of recessed portions. Each of the plurality of heaters includes a body portion having a pillar shape and a wiring portion having a meander shape inside the body portion in a longitudinal direction. The wiring portion includes a plurality of fold-back portions. The fold-back portion positioned on a front end side of the body portion is positioned in the recessed portion.

### CROSS-REFERENCE TO RELATED APPLICATIONS

This application is national stage application of International Application No. PCT/JP2023/015380, filed on Apr. 17, 2023, which designates the united states, incorporated herein by reference, and which claims the benefit of priority from Japanese Patent Application No. 2022-073551, filed on Apr. 27, 2022, the entire contents of which are incorporated herein by reference.

### TECHNICAL FIELD

An embodiment of the disclosure relates to a heating device.

### BACKGROUND OF INVENTION

In the related art, a heating device is known including a heating plate in which each of a plurality of cartridge heaters is inserted into a respective one of a plurality of recessed portions formed in a back surface positioned on an opposite side to a heating surface. The heating device brings a target object into contact with the heating plate to heat the target object (see Patent Document 1).

### CITATION LIST

### Patent Literature

Patent Document 1: JP 2016-207595 A

### SUMMARY

In an aspect of an embodiment, a heating device includes a heating plate and a plurality of heaters. The heating plate includes a heating surface and a plurality of recessed portions on a back surface opposite to the heating surface. Each of the plurality of heaters is positioned in a respective one of the plurality of recessed portions. Each of the plurality of heaters includes a body portion having a pillar shape and a wiring portion having a meander shape inside the body portion in a longitudinal direction. The wiring portion includes a plurality of fold-back portions. The fold-back portion positioned on a front end side of the body portion is positioned in the recessed portion.

### BRIEF DESCRIPTION OF THE DRAWINGS

FIG. 1 is a side view of a heating device according to an embodiment in a view from a Y-axis negative direction.

FIG. 2 is a cross-sectional view of a heater according to the embodiment.

FIG. 3 is a plan view of the heating device according to the embodiment in a view from a Z-axis positive direction.

FIG. 4 is a cross-sectional view taken along a line IV-IV illustrated in FIG. 3.

FIG. 5 is a cross-sectional view taken along a line V-V illustrated in FIG. 3.

FIG. 6 is a side view of the heating device according to the embodiment in a view from an X-axis negative direction.

FIG. 7 is a cross-sectional view taken along a line VII-VII illustrated in FIG. 6.

FIG. 8 is a schematic view for describing an example of a positional relationship between fold-back portions included in a heat generating resistor of each of a plurality of heaters and a respective one of recessed portions of a heating plate.

FIG. 9 is a cross-sectional view taken along a line IX-IX illustrated in FIG. 8.

FIG. 10 is a view illustrating another shape of the recessed portion.

FIG. 11 is a view illustrating another shape of the recessed portion.

FIG. 12 is a view illustrating another shape of the recessed portion.

FIG. 13 is a schematic view for describing another example of the positional relationship between the fold-back portions included in the heat generating resistor of each of the plurality of heaters and a respective one of the recessed portions of the heating plate.

FIG. 14 is a schematic view for describing another example of the positional relationship between connecting regions of the heat generating resistor and lead wirings and a respective one of the recessed portions of the heating plate.

FIG. 15 is a view illustrating another example in the inserted state of the heater according to the embodiment.

### DESCRIPTION OF EMBODIMENTS

Forms (hereinafter, referred to as “embodiments”) for implementing a heating device according to the present disclosure will be described in detail below with reference to the accompanying drawings. Note that the embodiments, which will be described below, are not intended to limit the heating device according to the present disclosure. The embodiments can be appropriately combined so as not to contradict each other in terms of processing content. In the following embodiments, the same portions are denoted by the same reference signs, and redundant explanations are omitted.

In the embodiments, which will be described below, expressions such as “constant”, “orthogonal”, “perpendicular”, and “parallel” may be used, but these expressions do not mean exactly “constant”, “orthogonal”, “perpendicular”, and “parallel”. In other words, it is assumed that the above expressions allow for deviations in manufacturing accuracy, installation accuracy, or the like.

The drawings, which will be referenced below, are schematic for illustrative purposes only. Therefore, the details may be omitted, and dimension ratios do not necessarily correspond to actual ones.

In each of the drawings, which will be referred to below, for ease of explanation, an X-axis direction, a Y-axis direction, and a Z-axis direction that are orthogonal to each other may be defined to illustrate a rectangular coordinate system in which a Z-axis positive direction is a vertically upward direction.

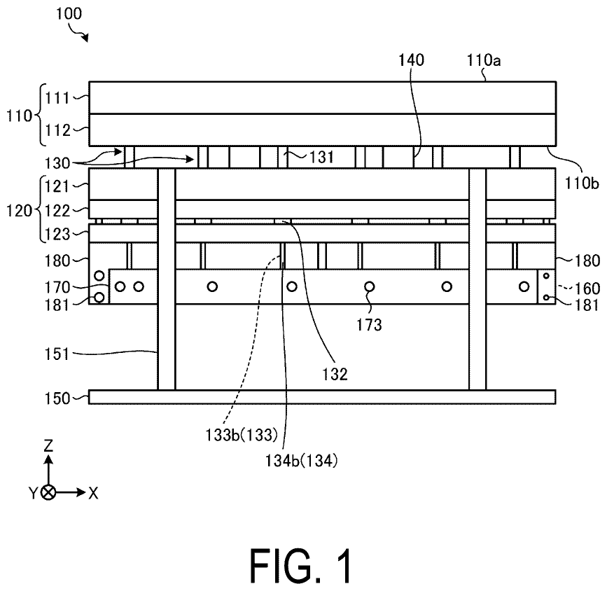

FIG. 1 is a side view of a heating device 100 according to the embodiment in a view from a Y-axis negative direction. Hereinafter, it is assumed that when the heating device 100 is brought into contact with a heating target object, a surface positioned on the heating target object side is defined as an “upper surface”, and a surface positioned on a side opposite to the heating target object is defined as a “lower surface”. Note that without being limited to this, the heating device 100 may be used upside down, for example, or may be used in a freely selected posture.

As illustrated in FIG. 1, the heating device 100 includes a heating plate 110, a fixture 120, a plurality of heaters 130, and a support plate 150. The heating device 100 also includes a plurality of anode-side collective electrodes 160, a plurality of cathode-side collective electrodes 170, and a plurality of insulating members 180.

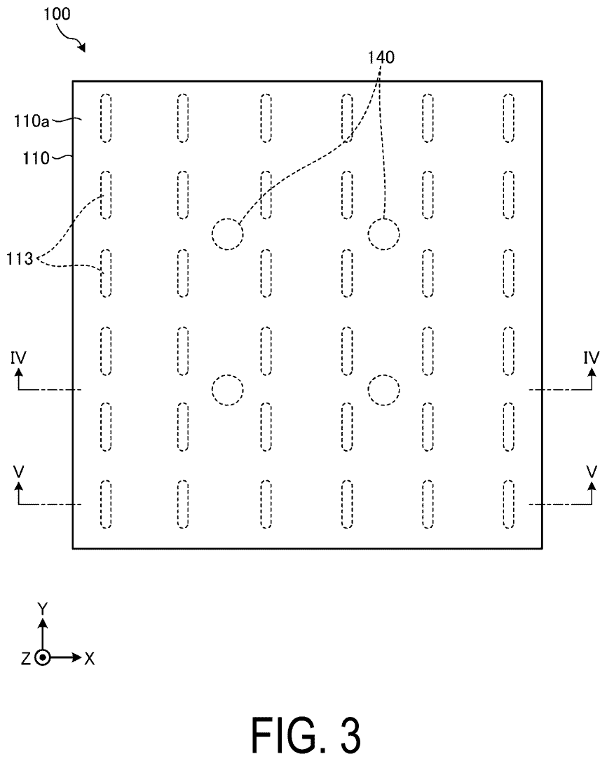

The heating plate 110 is, for example, a plate-shaped member made of a metal. The heating plate 110 includes an upper surface 110a configured to come into contact with a heating target object. That is, the upper surface 110a of the heating plate 110 serves as a heating surface for heating the heating target object. The upper surface 110a is used for heating, for example, a metal mold as an example of the heating target object. A plurality of recessed portions 113 (see FIG. 3 and FIG. 5) into which the plurality of heaters 130 are respectively inserted are formed at a lower surface 110b of the heating plate 110 on the opposite side to the heating surface.

Each of the plurality of heaters 130 is inserted into a respective one of the plurality of recessed portions 113. Thus, the plurality of heaters 130 are arranged perpendicular to the upper surface 110a of the heating plate 110 serving as the heating surface. In this way, arranging the plurality of heaters 130 perpendicularly to the heating surface of the heating plate 110 reduces a variation in distance between the plurality of heaters 130 and the heating surface, resulting in an improvement in thermal uniformity within the heating surface. The heater 130 has a temperature distribution in the longitudinal direction. On the other hand, arranging the plurality of heaters 130 perpendicularly to the heating surface of the heating plate 110 can reduce the occurrence of a temperature difference, due to the temperature distribution of the heaters 130, between a center portion and an outer peripheral portion of the upper surface 110a.

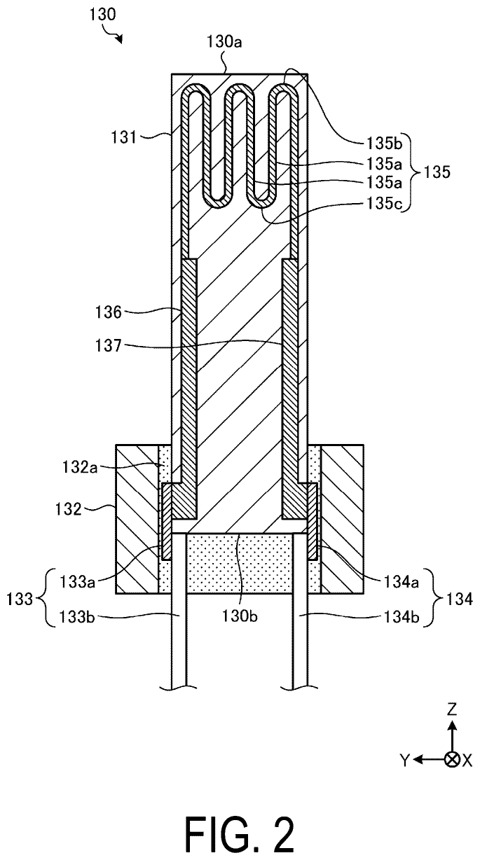

Here, a configuration of the heater 130 will be described with reference to FIG. 2. FIG. 2 is a cross-sectional view of the heater 130 according to the embodiment.

As illustrated in FIG. 2, according to the embodiment, the heater 130 includes a heater body 131, a cover member 132, an anode-side lead electrode 133, and a cathode-side lead electrode 134.

The heater body 131 is a ceramic heater. The heater body 131 has a rectangular plate shape in a cross-sectional view perpendicular to the X-axis direction, and includes a front end portion 130a and a base end portion 130b. The heater body 131 is inserted into the recessed portion 113 from the front end portion 130a side.

The heater body 131 includes a heat generating resistor 135 (an example of a wiring portion) and lead wirings 136 and 137 (an example of a lead wire portion) inside a ceramic body. Implementing the heater body 131 as the ceramic heater can reduce seizure between the heating plate 110 made of a metal and the heater body 131. Therefore, for example, a problem that the heater 130 cannot be replaced due to the seizure of the heater body 131 on the heating plate 110 is unlikely to occur.

The heat generating resistor 135 has a meandering wiring pattern repeatedly folded back between the front end portion 130a side and the base end portion 130b side of the heater body 131. To be specific, the heat generating resistor 135 includes a plurality of linear portions 135a extending along the longitudinal direction (here, the Z-axis direction) of the heater body 131, and fold-back portions 135b and 135c connecting two adjacent linear portions 135a on the front end side and the base end side of the heater body 131. The lead wiring 136 is connected to one end portion of the heat generating resistor 135, and the lead wiring 137 is connected to the other end portion of the heat generating resistor 135.

A length of the heater body 131, that is, a length of the ceramic body may be, for example, equal to or more than about 1 mm and equal to or less than about 200 mm. Outer dimensions of the ceramic body can be, for example, equal to or more than about 0.5 mm and equal to or less than about 100 mm.

A shape of the heater body 131, that is, a shape of the ceramic body is, for example, a rectangular pillar shape. Note that the shape of the heater body 131 is not limited to the rectangular pillar shape, and may be a circular pillar shape or an elliptical pillar shape, for example. Examples of the circular pillar shape or the elliptical pillar shape of the heater body 131 includes a tubular shape whose center is hollowed out. The ceramic body is made of a material such as an insulating ceramic. Example materials of the ceramic body include an oxide ceramic, a nitride ceramic, and a carbide ceramic.

The heat generating resistor 135 is a member that generates heat when an electrical current flows therethrough. One end portion of the heat generating resistor 135 is connected to a pad portion 133a of the anode-side lead electrode 133, which will be described later, through the lead wiring 136. The other end portion of the heat generating resistor 135 is connected to a pad portion 134a of the cathode-side lead electrode 134, which will be described later, through the lead wiring 137.

The heat generating resistor 135 may contain, for example, a high-resistance conductor containing tungsten, molybdenum, or the like. Regarding dimensions of the heat generating resistor 135, for example, a width may be equal to or more than 0.1 mm and equal to or less than 5 mm, a thickness may be equal to or more than 0.05 mm and equal to or less than 0.3 mm, and a total length may be equal to or more than 1 mm and equal to or less than 500 mm. The heat generating resistor 135 may be made of, for example, an electrically conductive ceramic containing tungsten carbide. In this case, a difference in thermal expansion between the ceramic body and the heat generating resistor 135 can be reduced. This allows thermal stress between the ceramic body and the heat generating resistor 135 to be reduced. As a result, durability of the heater body 131 can be enhanced.

The lead wiring 136 connects one end portion of the heat generating resistor 135 and the pad portion 133a of the anode-side lead electrode 133. The lead wiring 137 connects the other end portion of the heat generating resistor 135 and the pad portion 134a of the cathode-side lead electrode 134.

The lead wirings 136 and 137 may contain, for example, a high-resistance conductor containing tungsten, or molybdenum, the same as, and/or similar to the heat generating resistor 135. The lead wirings 136 and 137 may be made of an electrically conductive ceramic containing tungsten carbide, for example. The lead wirings 136 and 137 are larger in width than the heat generating resistor 135. This allows electrical resistance values of the lead wirings 136 and 137 to be made smaller than an electrical resistance value of the heat generating resistor 135. As a result, heat generation amounts can be reduced in the lead wirings 136 and 137.

The cover member 132 has a tubular shape surrounding an outer peripheral surface of the heater body 131. The cover member 132 is at a position corresponding to the pad portion 133a of the anode-side lead electrode 133 and the pad portion 134a of the cathode-side lead electrode 134 in the longitudinal direction (here, the Z-axis direction) of the heater body 131. The cover member 132 covers the pad portion 133a of the anode-side lead electrode 133 and the pad portion 134a of the cathode-side lead electrode 134. A space formed by an inner peripheral surface of the cover member 132 is filled with a bonding material 132a that bonds the cover member 132 and the heater body 131.

The cover member 132 is made of, for example, an insulating ceramic. The material of the cover member 132 may be, for example, alumina, silicon nitride, or the like.

Each of the anode-side lead electrode 133 and the cathode-side lead electrode 134 is fixed on one end portion (the base end portion 130b) side of the heater body 131. One end of the anode-side lead electrode 133 is connected to an external power supply through the anode-side collective electrode 160, which will be described later, and the other end thereof is electrically connected to the heat generating resistor 135 through the lead wiring 136. One end of the cathode-side lead electrode 134 is connected to the external power supply through the cathode-side collective electrode 170, which will be described later, and the other end thereof is electrically connected to the heat generating resistor 135 through the lead wiring 137.

Each of the anode-side lead electrode 133 and the cathode-side lead electrode 134 is constituted by a wire containing a metal material such as nickel, iron, or a nickel-based heat-resistant alloy.

The anode-side lead electrode 133 includes the pad portion 133a and a terminal portion 133b. The pad portion 133a is a planar portion positioned on a surface of the heater body 131, and is electrically connected to one end portion of the heat generating resistor 135 through the lead wiring 136. The terminal portion 133b is electrically connected to the pad portion 133a and extends outward in the longitudinal direction of the heater body 131 (here, in the Z-axis negative direction) from the base end portion 130b of the heater body 131. A cross section of the terminal portion 133b may be, for example, circular, elliptical, or rectangular. An outer diameter of the terminal portion 133b may be, for example, equal to or more than 0.5 mm and equal to or less than 2.0 mm.

The cathode-side lead electrode 134 includes the pad portion 134a and the terminal portion 134b. The pad portion 134a is a planar portion positioned on the surface of the heater body 131, and is electrically connected to the other end portion of the heat generating resistor 135 through the lead wiring 137. The terminal portion 134b is electrically connected to the pad portion 134a and extends outward in the longitudinal direction of the heater body 131 (here, in the Z-axis negative direction) from the base end portion 130b of the heater body 131. A cross section of the terminal portion 134b may be, for example, circular, elliptical, or rectangular. An outer diameter of the terminal portion 134b may be, for example, equal to or more than 0.5 mm and equal to or less than 2.0 mm.

As described above, the lead electrodes (the anode-side lead electrode 133 and the cathode-side lead electrode 134) of the heater 130 include the pad portions 133a and 134a positioned on the surface of the heater body 131 and the terminal portions 133b and 134b respectively connected to the pad portions 133a and 134a. In the heater 130 configured as described above, since the pad portions 133a and 134a function as buffer members, stresses are unlikely to be concentrated. Therefore, the heater 130 configured as described above has high durability.

Each of the plurality of heaters 130 included in the heating device 100 is inserted into a respective one of the plurality of recessed portions 113 formed at the lower surface 110b of the heating plate 110. FIG. 3 is a plan view of the heating device 100 according to the embodiment in a view from the Z-axis positive direction.

In FIG. 3, the upper surface 110a of the heating plate 110 serving as the heating surface is illustrated in a rectangular plate shape, and positions of the plurality of recessed portions 113 are illustrated by using dashed lines. As an example, the plurality of recessed portions 113 illustrated in FIG. 3 are arranged in six rows and six columns. That is, according to the embodiment, the heating plate 110 includes thirty-six recessed portions 113 in total. Note that the arrangement and the number of the plurality of recessed portions 113 are not limited to those of the illustrated example.

Returning to FIG. 1, description of the fixture 120 will be given. The fixture 120 is spaced apart from the heating plate 110. Each of the plurality of heaters 130 inserted into a respective one of the plurality of recessed portions 113 is fixed to the fixture 120. How the heater 130 is fixed to the fixture 120 will be described later.

The support plate 150 is fixed to the fixture 120 by using a plurality of pillar-shaped members 151 in a state of being separated from the fixture 120. Since the support plate 150 is positioned away from the fixture 120, a space for arranging the terminal portions 133b and 134b of the heaters 130, in other words, a space for arranging the anode-side collective electrodes 160 and the cathode-side collective electrodes 170, which will be described later, can be secured between the support plate 150 and the fixture 120. Note that the support plate 150 and the plurality of pillar-shaped members 151 may be omitted as necessary.

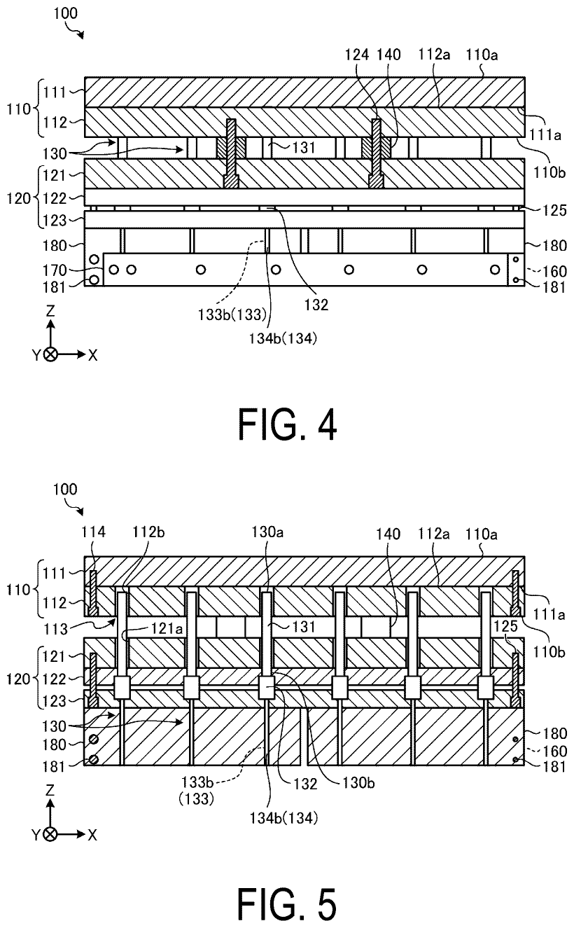

FIG. 4 is a cross-sectional view taken along a line IV-IV illustrated in FIG. 3. FIG. 5 is a cross-sectional view taken along a line V-V illustrated in FIG. 3. Note that in FIG. 4 and FIG. 5, the support plate 150 and the plurality of pillar-shaped members 151 are not illustrated.

As illustrated in FIG. 4 and FIG. 5, in the heating device 100, each of the plurality of heaters 130 is fixed to the fixture 120 and inserted into a respective one of the plurality of recessed portions 113 of the heating plate 110.

The heating plate 110 includes a first plate member 111 and a second plate member 112.

The first plate member 111 is a plate-shaped member including the upper surface 110a of the heating plate 110 serving as the heating surface. The first plate member 111 is joined to the second plate member 112 by using a fixing member 114 such as a bolt, for example. That is, the lower surface 111a on the opposite side of the upper surface 110a of the first plate member 111 is a joint surface joined to the second plate member 112.

The second plate member 112 is a plate-shaped member including an upper surface 112a serving as a jointed surface to be joined to the joint surface of the first plate member 111 and a lower surface 110b positioned on the opposite side of the upper surface 112a. A plurality of through holes 112b are formed at the lower surface 110b. The lower surface 111a of the first plate member 111 is exposed from each of the plurality of through holes 112b.

Each of the plurality of through holes 112b and the lower surface 111a of the first plate member 111 exposed from a respective one of the plurality of through holes 112b form a respective one of the plurality of recessed portions 113. That is, an inner wall surface of each through hole 112b forms an inner side surface of the corresponding recessed portion 113, and the lower surface 111a of the first plate member 111 forms a bottom surface (the top surface in the posture illustrated in FIG. 5) of each recessed portion 113. The front end portions 130a of each of the plurality of heaters 130 is positioned in a respective one of the plurality of recessed portions 113 when each of the plurality of heaters 130 is inserted into the respective one of the plurality of recessed portions 113. The heating plate 110 does not need to be divided into two members of the first plate member 111 and the second plate member 112. In the heating plate 110, portions corresponding to the first plate member 111 and the second plate member 112 may be integrally formed of a plate-shaped member made of a metal. The heating plate 110 includes the plurality of recessed portions 113 at the back surface positioned opposite to the heating surface of the integrally formed plate-shaped member. Integrally forming the heating plate 110 enables a manufacturing process of the heating device 100 to be simplified.

The fixture 120 includes a fixing plate 121 and a plurality of fixing bars 122 and 123.

The fixing plate 121 is, for example, a plate-shaped member made of a metal. A gap is formed between the fixing plate 121 and the heating plate 110, and the fixing plate 121 is coupled to the heating plate 110 by using a connection member 124 such as a bolt, for example. Thus, the fixing plate 121 is separated from the heating plate 110. Arranging the fixing plate 121 away from the heating plate 110 allows reduction of an increase in temperature of fixing portions (for example, the fixing bars 122 and 123) of the plurality of heaters 130 to the fixture 120. On the other hand, since the heat taken away from the heating plate 110 by the fixing plate 121 is reduced, an increase in temperature of the heating plate 110 can be promoted.

The fixing plate 121 includes a plurality of through holes 121a each of which is at a position corresponding to a respective one of the plurality of recessed portions 113. Each of the plurality of heaters 130 is inserted into a respective one of the plurality of through holes 121a. Hereinafter, for convenience of description, when it is not necessary to particularly make distinction, the plurality of recessed portions 113, the plurality of through holes 121a, and the plurality of heaters 130 are simply referred to as the “recessed portions 113”, the “fixing holes 120a”, and the “heaters 130”, respectively.

The heater body 131 of the heater 130 passes through the through hole 121a, and the front end portion 130a thereof is inserted into the recessed portion 113. The base end portion 130b of the heater body 131 protrudes from the lower surface of the fixing plate 121 in a direction away from the upper surface 110a of the heating plate 110 serving as the heating surface. The anode-side lead electrode 133 and the cathode-side lead electrode 134 described above are positioned at the base end portion 130b of the heater body 131. The anode-side lead electrode 133 and the cathode-side lead electrode 134 are provided at the base end portion 130b of the heater body 131 protruding in the direction away from the upper surface 110a of the heating plate 110 serving as the heating surface, which allows the anode-side lead electrode 133 and the cathode-side lead electrode 134 to be kept away from the heating surface. Therefore, according to this configuration, heat transfer to the anode-side lead electrode 133 and the cathode-side lead electrode 134 can be reduced.

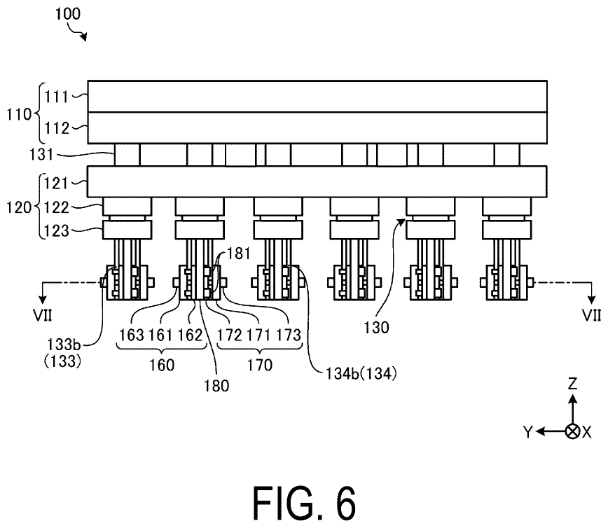

Each of the fixing bars 122 and 123 is, for example, a bar-shaped member made of a metal. The fixing bars 122 and 123 interpose the cover members 132 of the plurality of heaters 130, and are coupled to the fixing plate 121 by using a connection member 125 such as a bolt. Accordingly, the fixing bars 122 and 123 can fix the plurality of heaters 130 to the fixing plate 121. In the embodiment, the heating device 100 includes thirty-six heaters 130, and a pair of fixing bars 122 and 123 interpose the cover members 132 of six heaters 130 aligned in a row among the thirty-six heaters 130. Accordingly, the pair of fixing bars 122 and 123 can fix positions of the six heaters 130 aligned in a row. The heating device 100 includes six pairs of fixing bars 122 and 123 in total (see FIG. 6).

A spacer member 140 is arranged between the heating plate 110 and the fixture 120. The spacer member 140 has a tubular shape, and the connection member 124 is inserted through the spacer member 140. Providing the spacer member 140 between the heating plate 110 and the fixture 120 can keep the heating plate 110 and the fixture 120 separated from each other, and can keep a distance between the heating plate 110 and the fixture 120. Therefore, this configuration can continuously reduce an increase in temperature of the fixture 120 caused by the heat transfer from the heating plate 110.

A material of the spacer member 140 is preferably, for example, a ceramic having thermal resistance. Example materials of the spacer member 140 include an oxide ceramic, a nitride ceramic, and a carbide ceramic. Accordingly, thermal expansion and thermal contraction of the spacer member 140 can be reduced, and thus wear of the spacer member 140 can be reduced.

Returning to FIG. 1, the anode-side collective electrode 160 is electrically connected to the anode-side lead electrodes 133 of a plurality of heaters 130. In the embodiment, the heating device 100 includes the thirty-six heaters 130. The anode-side collective electrode 160 is electrically connected to the anode-side lead electrodes 133 of six heaters 130 that are aligned in a row and that are fixed to the pair of fixing bars 122 and 123, among the thirty-six heaters 130. The heating device 100 includes six anode-side collective electrodes 160 in total (see FIG. 6).

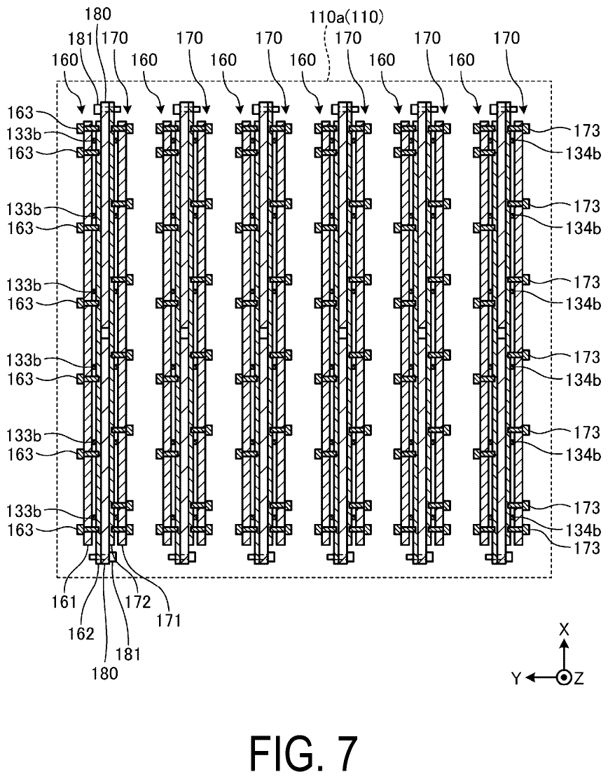

The cathode-side collective electrode 170 is electrically connected to the cathode-side lead electrodes 134 of a plurality of heaters 130. In the embodiment, the heating device 100 includes the thirty-six heaters 130, and the cathode-side collective electrode 170 is electrically connected to the cathode-side lead electrodes 134 of six heaters 130 that are aligned in a row and that are fixed to the pair of fixing bars 122 and 123, among the thirty-six heaters 130. The heating device 100 includes six cathode-side collective electrodes 170 in total (see FIG. 7).

The insulating member 180 is, for example, a plate-shaped member made of a ceramic having an insulating property, and is interposed between the anode-side collective electrode 160 and the cathode-side collective electrode 170. In the embodiment, the heating device 100 includes two insulating members 180 for each set of the anode-side collective electrode 160 and the cathode-side collective electrode 170. The two insulating members 180 are interposed between one set of the anode-side collective electrode 160 and the cathode-side collective electrode 170.

As described above, the heating device 100 includes the anode-side collective electrode 160 connected to two or more anode-side lead electrodes 133 provided in two or more heaters 130 among the plurality of heaters 130 included in the heating device 100. The heating device 100 includes the cathode-side collective electrode 170 connected to two or more cathode-side lead electrodes 134 provided in two or more heaters 130 among the plurality of heaters 130 included in the heating device 100. The heating device 100 further includes the insulating members 180 interposed between the anode-side collective electrode 160 and the cathode-side collective electrode 170.

Heat generated by the plurality of (here, six) heaters 130 is transferred to the two collective electrodes (the anode-side collective electrode 160 and the cathode-side collective electrode 170) corresponding to different polarities through the lead electrodes (the anode-side lead electrode 133 and the cathode-side lead electrode 134) having the different polarities. The heat transferred to the two collective electrodes (the anode-side collective electrode 160 and the cathode-side collective electrode 170) corresponding to the respective polarities is transferred to the insulating members 180 interposed between the two collective electrodes. As a result, discrete dissipation of the heat generated by the respective heaters 130 from the lead electrodes having the different polarities of the respective heaters 130 can be reduced, which can improve thermal uniformity.

Note that the number of insulating members 180 interposed between one pair of the anode-side collective electrode 160 and the cathode-side collective electrode 170 is not limited to the illustrated example.

Here, the configuration of the anode-side collective electrode 160, the cathode-side collective electrode 170, and the insulating members 180 will be described more specifically with reference to FIG. 6 and FIG. 7. FIG. 6 is a side view of the heating device 100 according to the embodiment in a view from the X-axis negative direction. FIG. 7 is a cross-sectional view taken along a line VII-VII illustrated in FIG. 6.

As illustrated in FIG. 6 and FIG. 7, the anode-side collective electrode 160 includes a first metal plate 161, a second metal plate 162, and a plurality of first fixing members 163. Each of the first metal plate 161 and the second metal plate 162 is a metal plate member having a rectangular cross-sectional shape. The first fixing member 163 detachably fixes the first metal plate 161 and the second metal plate 162. The first fixing member 163 is, for example, a bolt.

The anode-side collective electrode 160 is electrically connected to the plurality of anode-side lead electrodes 133 by interposing the terminal portions 133b of the plurality of anode-side lead electrodes 133 between the first metal plate 161 and the second metal plate 162. To be specific, in the embodiment, the first metal plate 161 and the second metal plate 162 extend along the X-axis direction, and interpose the plurality of (here, six) terminal portions 133b aligned along the X-axis direction.

With this configuration, since the plurality of anode-side lead electrodes 133 can be connected in a straight line, the plurality of anode-side lead electrodes 133 can be connected at the shortest distance. Even when lengths of the terminal portions 133b vary, the connection is easily performed.

Gaps are provided between the terminal portions 133b of the plurality of (here, six) anode-side lead electrodes 133, and then, the first metal plate 161 and the second metal plate 162 interpose the terminal portions 133b of the plurality of anode-side lead electrodes 133. This configuration enables the first metal plate 161 and the second metal plate 162 to function as a spring. Therefore, with this configuration, strength for interposing the terminal portions 133b can be maintained over a long period of time. Since stress caused by a difference in thermal expansion and contraction between the first metal plate 161 and the second metal plate 162 and the insulating members 180 is relaxed by the first metal plate 161 and the second metal plate 162 serving as the spring, damage to the insulating members 180 is reduced.

The first fixing member 163 fixes the first metal plate 161 and the second metal plate 162 at a position corresponding to each of the gaps between the terminal portions 133b of the plurality of (here, six) anode-side lead electrodes 133. With this configuration, contact areas between the second metal plate 162 and the insulating members 180 can be reduced by bending the first metal plate 161 and the second metal plate 162 in directions approaching each other. Therefore, according to this configuration, generation of stress caused by a difference in thermal expansion and contraction between the first metal plate 161 and the second metal plate 162 and the insulating members 180 is reduced, and the damage to the insulating members 180 is further reduced.

The second metal plate 162 is in contact with the insulating members 180. The second metal plate 162 has a smaller thickness than that of the first metal plate 161. Making the second metal plate 162 small in thickness as described above improves thermal conductivity of the second metal plate 162, which can promote heat transfer from the terminal portions 133b of the heaters 130 to the insulating members 180 through the second metal plate 162. Therefore, according to this configuration, the thermal uniformity can be further improved. Since the second metal plate 162 is easily elastically deformed, thermal stress acting on the insulating members 180 from the second metal plate 162 can be relaxed.

As illustrated in FIG. 7, a plurality of (here, six) anode-side collective electrodes 160 are aligned along the Y-axis direction. As illustrated in FIG. 7, in a plan view seen from a direction perpendicular to the upper surface 110a serving as the heating surface of the heating plate 110, the connection positions between the anode-side collective electrodes 160 and the terminal portions 133b overlap the upper surface 110a of the heating plate 110. Connection of the anode-side collective electrodes 160 and the terminal portions 133b within a range of the heating region in this manner can reduce dissipation of the heat from the heaters 130 to the outside of the heating device 100, as compared with a configuration in which the anode-side collective electrodes 160 and the terminal portions 133b are connected at the outside of the heating region, for example. Therefore, according to this configuration, the thermal uniformity can be further improved.

As illustrated in FIG. 6 and FIG. 7, the cathode-side collective electrode 170 includes a third metal plate 171, a fourth metal plate 172, and a plurality of second fixing members 173. Each of the third metal plate 171 and the fourth metal plate 172 is a metal plate member having a rectangular cross-sectional shape. The second fixing member 173 detachably fixes the third metal plate 171 and the fourth metal plate 172. The second fixing member 173 is, for example, a bolt.

The cathode-side collective electrode 170 is electrically connected to a plurality of cathode-side lead electrodes 134 by interposing the terminal portions 134b of the plurality of cathode-side lead electrodes 134 between the third metal plate 171 and the fourth metal plate 172. To be specific, in the embodiment, the third metal plate 171 and the fourth metal plate 172 extend along the X-axis direction, and interpose the plurality of (here, six) terminal portions 134b aligned along the X-axis direction.

With this configuration, since the plurality of cathode-side lead electrodes 134 can be connected in a straight line, the plurality of cathode-side lead electrodes 134 can be connected at the shortest distance. Even when lengths of the terminal portions 134b vary, the connection is easily performed.

Gaps are provided between the terminal portions 134b of the plurality of (here, six) cathode-side lead electrodes 134, and then, the third metal plate 171 and the fourth metal plate 172 interpose the terminal portions 134b of the plurality of cathode-side lead electrodes 134. This configuration enables the third metal plate 171 and the fourth metal plate 172 to function as a spring. Therefore, with this configuration, strength for interposing the terminal portions 134b can be maintained over a long period of time. Since stress caused by a difference in thermal expansion and contraction between the third metal plate 171 and the fourth metal plate 172 and the insulating members 180 is relaxed by the third metal plate 171 and the fourth metal plate 172 serving as the spring, damage to the insulating members 180 is reduced.

The second fixing member 173 fixes the third metal plate 171 and the fourth metal plate 172 at a position corresponding to each of the gaps between the terminal portions 134b of the plurality of (here, six) cathode-side lead electrodes 134. With this configuration, contact areas between the fourth metal plate 172 and the insulating members 180 can be reduced by bending the third metal plate 171 and the fourth metal plate 172 in directions approaching each other. Therefore, according to this configuration, generation of stress caused by a difference in thermal expansion and contraction between the third metal plate 171 and the fourth metal plate 172 and the insulating members 180 is reduced, and the damage to the insulating members 180 is further reduced.

The fourth metal plate 172 is in contact with the insulating members 180. The fourth metal plate 172 has a smaller thickness than that of the third metal plate 171. Making the fourth metal plate 172 small in thickness as described above improves thermal conductivity of the fourth metal plate 172, which can promote heat transfer from the terminal portions 133b of the heaters 130 to the insulating members 180 through the fourth metal plate 172. Therefore, according to this configuration, the thermal uniformity can be further improved. Since the fourth metal plate 172 is easily elastically deformed, thermal stress acting on the insulating members 180 from the fourth metal plate 172 can be relaxed.

Further, as illustrated in FIG. 7, the terminal portions 134b of the adjacent anode-side lead electrodes 133 and the terminal portions 134b of the adjacent cathode-side lead electrodes 134 are positioned on opposite sides with the insulating member 180 interposed therebetween. The first fixing member 163 fixes the first metal plate 161 and the second metal plate 162 at a position closer to the other of the adjacent anode-side lead electrodes 133 than one of the adjacent anode-side lead electrodes 133. The second fixing member 173 fixes the third metal plate 171 and the fourth metal plate 172 at a position closer to the other second lead electrode than to the other second lead electrode corresponding to one anode-side lead electrode described above, of the adjacent cathode-side lead electrodes 134. With this configuration, since the fixing position of the first metal plate 161 and the second metal plate 162 by the first fixing member 163 and the fixing position of the third metal plate 171 and the fourth metal plate 172 by the second fixing member 173 are shifted from each other, contact portions between the metal plates and the insulating members 180 are shifted from each other. Therefore, according to this configuration, generation of stress caused by a difference in thermal expansion and contraction between the second metal plate 162 and the fourth metal plate 172 and the insulating members 180 is reduced, and the damage to the insulating members 180 is further reduced.

As illustrated in FIG. 6 and FIG. 7, the insulating member 180 is fixed to one of the anode-side collective electrode 160 and the cathode-side collective electrode 170 by a fixing member 181 such as a bolt. For example, as illustrated in FIG. 7, the anode-side collective electrode 160 and the cathode-side collective electrode 170 extend along the X-axis direction parallel to the upper surface 110a serving as the heating surface of the heating plate 110. The insulating member 180 is fixed to one end portion in the extending direction (here, the X-axis direction) of one of the anode-side collective electrode 160 and the cathode-side collective electrode 170 by the fixing member 181 in a cantilevered state. Specifically, one of the two insulating members 180 interposed between the anode-side collective electrode 160 and the cathode-side collective electrode 170 is fixed to an end portion of the second metal plate 162 of the anode-side collective electrode 160 on the negative side in the X-axis direction by the fixing member 181 in a cantilevered state. The other of the two insulating members 180 interposed between the anode-side collective electrode 160 and the cathode-side collective electrode 170 is fixed to an end portion of the fourth metal plate 172 of the cathode-side collective electrode 170 on the positive side in the X-axis direction by the fixing member 181 in a cantilevered state.

In this way, fixing the insulating member 180 to one of the anode-side collective electrode 160 and the cathode-side collective electrode 170 can reduce thermal stress acting on the insulating member 180, as compared with a configuration in which the insulating member 180 is fixed to both the anode-side collective electrode 160 and the cathode-side collective electrode 170. Therefore, according to this configuration, the damage to the insulating members 180 is further reduced. Since the insulating member 180 is fixed to one end portion in the extending direction (here, the X-axis direction) of one of the anode-side collective electrode 160 and the cathode-side collective electrode 170 in a cantilevered state, the thermal stress acting on the insulating members 180 can be further reduced.

As illustrated in FIG. 7, the two insulating members 180 interposed between the anode-side collective electrode 160 and the cathode-side collective electrode 170 are positioned side by side between the anode-side collective electrode 160 and the cathode-side collective electrode 170 in the direction (X-axis direction) parallel to the upper surface 110a serving as the heating surface of the heating plate 110. Since the two insulating members 180 are positioned side by side between the anode-side collective electrode 160 and the cathode-side collective electrode 170 in this manner, the thermal stress on each insulating member 180 can be reduced as compared with a configuration in which one insulating member 180 is positioned between the anode-side collective electrode 160 and the cathode-side collective electrode 170. Therefore, according to this configuration, the damage to the insulating members 180 is further reduced.

Note that in the above description, the two insulating members 180 are aligned between the anode-side collective electrode 160 and the cathode-side collective electrode 170 in the direction (X-axis direction) parallel to the upper surface 110a serving as the heating surface of the heating plate 110. However, the arrangement of the insulating members 180 is not limited to this. For example, the two insulating members 180 may be positioned side by side between the anode-side collective electrode 160 and the cathode-side collective electrode 170 in a direction (Z-axis direction) perpendicular to the upper surface 110a serving as the heating surface of the heating plate 110.

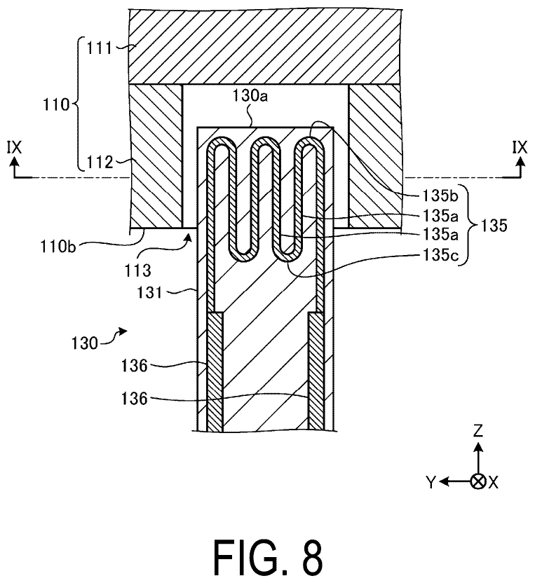

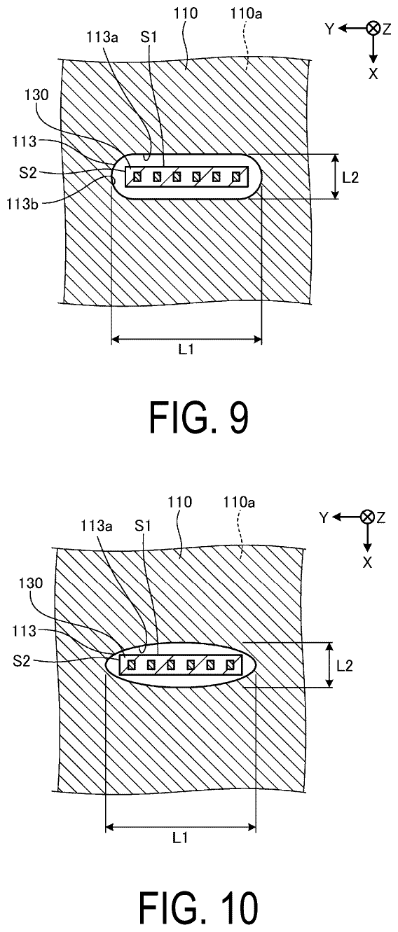

Hereinafter, an example of a positional relationship between the fold-back portions 135b and 135c included in the heat generating resistor 135 of each of the plurality of heaters 130 and a respective one of the recessed portions 113 of the heating plate 110 will be described with reference to FIG. 8 and FIG. 9. FIG. 8 is a schematic view for describing an example of a positional relationship between the fold-back portions 135b and 135c included in the heat generating resistor 135 of each of the plurality of heaters 130 and a respective one of the recessed portions 113 of the heating plate 110. FIG. 9 is a cross-sectional view taken along a line IX-IX illustrated in FIG. 8.

As illustrated in FIG. 8, in the heating device 100 according to the embodiment, among the fold-back portions 135b and 135c included in the heat generating resistor 135 of each of the plurality of heaters 130, at least the fold-back portion 135b positioned on the front end portion 130a side of the heater body 131 is positioned in the recessed portion 113.

For example, in the example illustrated in FIG. 8, the fold-back portion 135c positioned on the base end portion 130b side of the heater body 131 is positioned outside the recessed portion 113, whereas the fold-back portion 135b positioned on the front end portion 130a side of the heater body 131 is positioned in the recessed portion 113. Also in the heaters 130 other than the heater 130 illustrated in FIG. 8, the fold-back portion 135b is positioned in the recessed portion 113.

The heater 130 incorporating the heat generating resistor 135 formed in the meander shape has a maximum heat generating zone at the fold-back portion 135b positioned on the front end portion 130a side of the heater body 131. Therefore, by positioning the fold-back portion 135b included in the heat generating resistor 135 of each of the plurality of heaters 130 in a respective one of the recessed portions 113, a position of the maximum heat generating zone of each heater 130 can be aligned with a position in the vicinity of the bottom surface of the recessed portion 113 along a depth direction of the recessed portion 113. Accordingly, discrete dissipation of heat generated by each of the heaters 130 from the opening of a respective one of the recessed portions 113 in the heating plate 110 can be reduced. Therefore, according to the embodiment, the heating device 100 can improve the thermal uniformity of the heating plate 110.

Each heater 130 is positioned (inserted) in the recessed portion 113 in a manner that the front end portion 130a of the heater body 131 and the bottom surface of the recessed portion 113 are not in contact with each other. Thus, when each heater 130 is thermally expanded, stress from the bottom surface of the recessed portion 113 is not applied on the front end portion 130a of the heater body 131. Thus, according to the embodiment, the heating device 100 can enhance the durability of the plurality of heaters 130. Since the front end portion 130a of the heater body 131 is positioned away from the bottom surface of the recessed portion 113, radiant heat from the maximum heat generating zone (that is, the fold-back portion 135b of the heat generating resistor 135) positioned on the front end portion 130a side of the heater body 131 can be transferred to the heating plate 110. Therefore, according to the embodiment, the heating device 100 can reduce the concentration of heat on a specific portion of the heating plate 110, and further improve the thermal uniformity of the heating plate 110.

As illustrated in FIG. 9, in a plan view seen from a direction (here, the Z-axis direction) perpendicular to the upper surface 110a of the heating plate 110 serving as the heating surface, a length L1 of the recessed portion 113 in the Y-axis direction (an example of a first direction) is longer than a length L2 in the X-axis direction (an example of a second direction). In other words, the shape of the recessed portion 113 is a shape in which the length L1 in the Y-axis direction is longer than the length L2 in the X-axis direction. To be specific, in the recessed portion 113, protruding curved surfaces 113b connect both ends in the Y-axis direction of two inner side surfaces 113a each of which has a linear shape in the X-axis direction to each other. In other words, the shape of the recessed portion 113 is a racetrack shape in which the protruding curved surfaces 113b each of which has a semicircular shape connect both ends in the Y-axis direction of the two inner side surfaces 113a each of which has the linear shape in the X-axis direction to each other in a plan view seen from the direction perpendicular to the upper surface 110a of the heating plate 110 serving as the heating surface. Each of the heaters 130 has a plate shape including a first surface S1 in the X-axis direction and a second surface S2 in the Y-axis direction. In other words, the shape of each heater 130 is a rectangular shape in which a longitudinal direction coincides with the Y-axis direction and a lateral direction coincides with the X-axis direction. The first surface S1 of each heater 130 in the lateral direction (here, the X-axis direction) faces the inner side surface 113a of the recessed portion 113 in the X-axis direction.

With this configuration, heat generated by each heater 130 is transferred from the first surface S1 toward the inner side surface 113a of the recessed portion 113, and thus heat transfer directions from the plurality of heaters 130 to the heating plate 110 can be aligned in the same direction (here, the X-axis direction). Therefore, according to the embodiment, the heating device 100 can further improve the thermal uniformity of the heating plate 110.

When the recessed portion 113 has the racetrack shape as illustrated in FIG. 9, the second surface S2 of each heater 130 in the longitudinal direction (here, the Y-axis direction) may face the protruding curved surface 113b of the recessed portion 113 in the Y-axis direction.

Each heater 130 has a temperature distribution in which the temperature decreases in the order of the first surface S1, the second surface S2, and a corner portion between the first surface S1 and the second surface S2. Accordingly, with this configuration, the second surface S2 and the corner portion of each heater 130 are close to the protruding curved surface 113b of the recessed portion 113, and thus heat transfer efficiency to the protruding curved surface 113b of the recessed portion 113 can be made close to heat transfer efficiency to the inner side surface 113a of the recessed portion 113. Therefore, according to the embodiment, the heating device 100 having this configuration can further improve the thermal uniformity of the heating plate 110.

When the shape of the recessed portion 113 is the racetrack shape as illustrated in FIG. 9, a width along the Y-axis direction of the inner side surface 113a of the recessed portion 113 in the X-axis direction may be smaller than a width of each heater 130 along the longitudinal direction (here, the Y-axis direction).

With this configuration, the second surface S2 and the corner portion of each heater 130 are closer to the protruding curved surface 113b of the recessed portion 113, as compared with a configuration in which a width along the Y-axis direction of the inner side surface 113a of the recessed portion 113 in the X-axis direction is larger than a width of each heater 130 along the longitudinal direction. This improves the heat transfer efficiency from each heater 130 to the protruding curved surface 113b of the recessed portion 113, which can further improve the thermal uniformity of the heating plate 110.

Note that in the example of FIG. 9, the shape of the recessed portion 113 is the racetrack shape, but the shape of the recessed portion 113 is not limited to the racetrack shape. That is, in a plan view seen from the direction (here, the Z-axis direction) perpendicular to the upper surface 110a of the heating plate 110 serving as the heating surface, the shape of the recessed portion 113 may be a shape other than the racetrack shape as long as the length L1 in the Y-axis direction is longer than the length L2 in the X-axis direction.

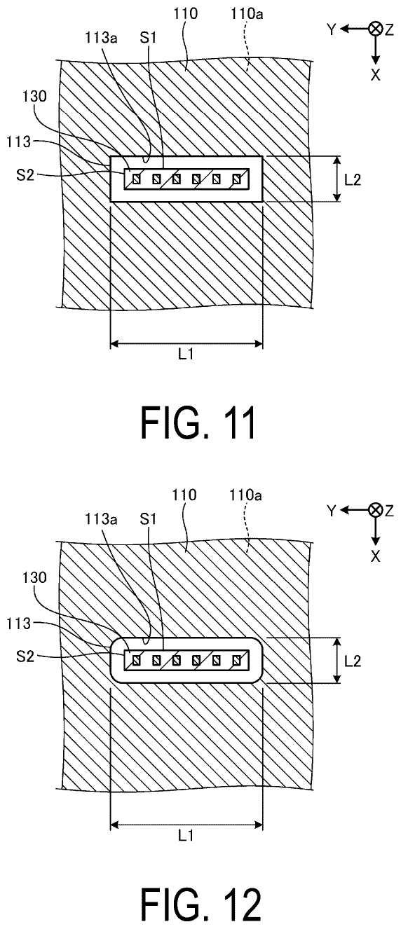

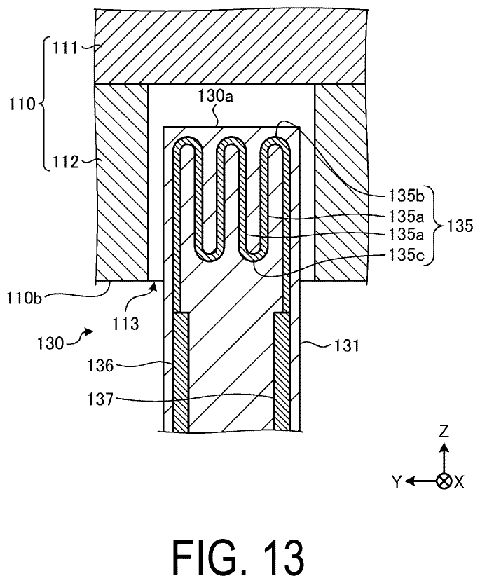

FIG. 10 to FIG. 12 are views illustrating other shapes of the recessed portion 113. For example, as illustrated in FIG. 10, the shape of the recessed portion 113 may be an elliptical shape in which the length L1 in the Y-axis direction is longer than the length L2 in the X-axis direction. For example, as illustrated in FIG. 11, the shape of the recessed portion 113 may be a rectangular shape in which the length L1 in the Y-axis direction is longer than the length L2 in the X-axis direction. For example, as illustrated in FIG. 12, the shape of the recessed portion 113 may have, for example, a rectangular shape whose corner portion is rounded. In any case, the shape of each heater 130 is a rectangular shape in which the longitudinal direction coincides with the Y-axis direction and the lateral direction coincides with the X-axis direction. The first surface S1 of each heater 130 in the lateral direction (here, the X-axis direction) faces the inner side surface 113a of the recessed portion 113 in the X-axis direction. Accordingly, heat transfer directions from the plurality of heaters 130 to the heating plate 110 can be aligned in the same direction (here, the X-axis direction), and as a result, the thermal uniformity of the heating plate 110 can be further improved.

FIG. 13 is a schematic view for describing another example of the positional relationship between the fold-back portions 135b and 135c included in the heat generating resistor 135 of each of the plurality of heaters 130 and a respective one of the recessed portions 113 of the heating plate 110.

As illustrated in FIG. 13, in the heating device 100 according to the embodiment, all the fold-back portions 135b and 135c included in the heat generating resistor 135 of each of the plurality of heaters 130 may be positioned in a respective one of the recessed portions 113.

For example, in the example illustrated in FIG. 13, in addition to the fold-back portion 135b positioned on the front end portion 130a side of the heater body 131, the fold-back portion 135c positioned on the base end portion 130b side of the heater body 131 is also positioned in the recessed portion 113.

With this configuration, heat from all the heat generating zones (heat generating zones including the fold-back portions 135b and 135c) of the heaters 130 can be transferred to the heating plate 110 through the respective recessed portions 113, which can further improve the thermal uniformity of the heating plate 110.

In the example illustrated in FIG. 13, connecting regions between the heat generating resistor 135 and the lead wirings 136 and 137 are positioned outside the recessed portion 113.

With this configuration, as compared with a configuration in which the connecting regions between the heat generating resistor 135 and the lead wirings 136 and 137 are positioned in the recessed portion 113, outside air easily comes into contact with the connecting regions between the heat generating resistor 135 and the lead wirings 136 and 137, which can lower the temperature of the connecting regions. Therefore, according to the embodiment, the heating device 100 having this configuration can reduce electrical resistance values at the connecting regions between the heat generating resistor 135 and the lead wirings 136 and 137, which can improve heat generating efficiency in the heat generating resistor 135.

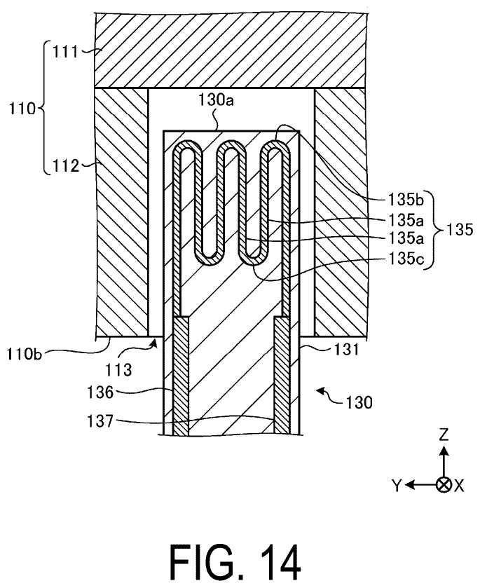

FIG. 14 is a schematic view for describing another example of the positional relationship between the connecting regions between the heat generating resistor 135 and the lead wirings 136 and 137 and the corresponding recessed portion 113 of the heating plate 110.

As illustrated in FIG. 14, the connecting regions between the heat generating resistor 135 and the lead wirings 136 and 137 may be positioned in the recessed portion 113.

With this configuration, as compared with a configuration in which the connecting regions between the heat generating resistor 135 and the lead wirings 136 and 137 are positioned outside the recessed portion 113, the temperature difference between the connecting regions and the heat generating resistor 135 is reduced, and the thermal stress is less likely to be concentrated on the connecting regions. Therefore, according to the embodiment, the heating device 100 having this configuration can improve the durability of the plurality of heaters 130.

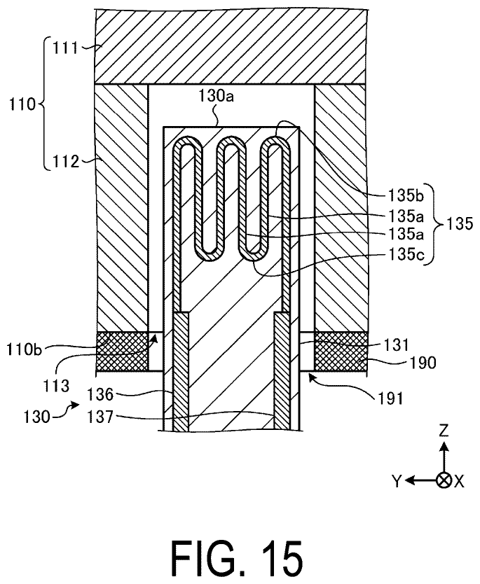

FIG. 15 is a view illustrating another example in the inserted state of the heater 130 according to the embodiment. As illustrated in FIG. 15, a thermal insulation material 190 may be positioned at the lower surface 110b of the heating plate 110. The thermal insulation material 190 includes a through hole 191 corresponding to the position of the recessed portion 113. Each heater 130 may be inserted into a respective one of the recessed portions 113 through the through hole 191 of the thermal insulation material 190.

This configuration can further reduce discrete dissipation of heat generated by each of the heaters 130 from the opening of a respective one of the recessed portions 113 in the heating plate 110. Therefore, according to the embodiment, the heating device 100 having this configuration can further improve the thermal uniformity of the heating plate 110.

Those skilled in the art can easily derive further effects and other embodiments. Thus, a wide variety of aspects of the present invention are not limited to the specific details and representative embodiment represented and described above. Accordingly, various changes are possible without departing from the spirit or scope of the general inventive concepts defined by the appended claims and their equivalents.

1. A heating device comprising:
a heating plate; and
a plurality of heaters,
wherein the heating plate comprises a heating surface and a plurality of recessed portions on a back surface opposite to the heating surface,
each of the plurality of heaters is positioned in a respective one of the plurality of recessed portions,
each of the heaters comprises a body portion having a pillar shape and a wiring portion having a meander shape inside the body portion in a longitudinal direction,
the wiring portion comprises a plurality of fold-back portions, and
the fold-back portion positioned on a front end side of the body portion is positioned in the recessed portion.

2. The heating device according to claim 1, wherein
in a plan view seen from a direction perpendicular to the heating surface, a length of the recessed portion in a first direction is longer than a length in a second direction orthogonal to the first direction,
each of the plurality of heaters has a plate shape and comprises a second surface in the first direction and a first surface in the second direction, and
the first surface of each of the plurality of heaters faces inner side surfaces of the recessed portion in the second direction.

3. The heating device according to claim 2, wherein
in the plan view seen from the direction perpendicular to the heating surface, both ends in the first direction of two of the inner side surfaces of the recessed portion are connected by a protruding curved surface and each of the two inner side surfaces of the recessed portion in the second direction has a linear shape, and
the second surface of each of the plurality of heaters faces the protruding curved surface of the recessed portion.

4. The heating device according to claim 1, wherein all of the plurality of fold-back portions included in the wiring portion are positioned in the recessed portion.

5. The heating device according to claim 4, wherein
each of the plurality of heaters further comprises a lead wire portion connected to an end portion of the wiring portion inside the body portion, and
a connecting region between the wiring portion and the lead wire portion is positioned in the recessed portion.

6. The heating device according to claim 4, wherein
each of the plurality of heaters further comprises a lead wire portion connected to an end portion of the wiring portion inside the body portion, and
a connecting region between the wiring portion and the lead wire portion is positioned outside the recessed portion.

7. The heating device according to claim 1, wherein each of the plurality of heaters is positioned in the recessed portion, and a front end of the body portion and a bottom surface of the recessed portion are not in contact with each other.

8. The heating device according to claim 1, wherein
a thermal insulation material is positioned on the back surface of the heating plate, and comprises a through hole corresponding to a position of the recessed portion, and
each of the plurality of heaters is positioned in the recessed portion through the through hole of the thermal insulation material.
